(19) United States
(12) Patent Application Publication
(10) Pub. No.: US 2006/0042146 A1
(43) Pub. Date: Mar. 2, 2006

(54) Brother's bait bag

(76) Inventors: James Andrew Waddy JR., Laurel, MD (US); Kevin Antonio Waddy, (US); James Joseph Becker, (US); Andrew Thomas Williams, (US)

Correspondence Address: JAMES ANDREW WADDY JR., 11680 South Laurel Dr. # 3A, Laurel, MD, 20708, US

(21) Appl. No.: 10/756,966

(22) Filed: Sep. 1, 2004

(51) Int. Cl. A01K 85/01; A01K 97/02

(52) U.S. Cl. 43/42.06; 43/44.99

(57) ABSTRACT

A fishing lure comprised of a bag formed of open mesh material closed at one end and open at the opposite end. Having a drawstring for drawing the open end closed. Thereby enclosing at least a portion of a fishhook placed within the bag, and a leader attached to the fishhook and extending through the open end drawstring portion of the bag. The bait may be placed on a fishhook and the bag then closed by the drawstring. The bait being readily visible, olfactory attractive to fish by reason of the open mesh characteristic of the bag, scent, or color of the bag, with a fishhook being readily able to penetrate the bag by reason of its open mesh characteristics for hooking a fish.

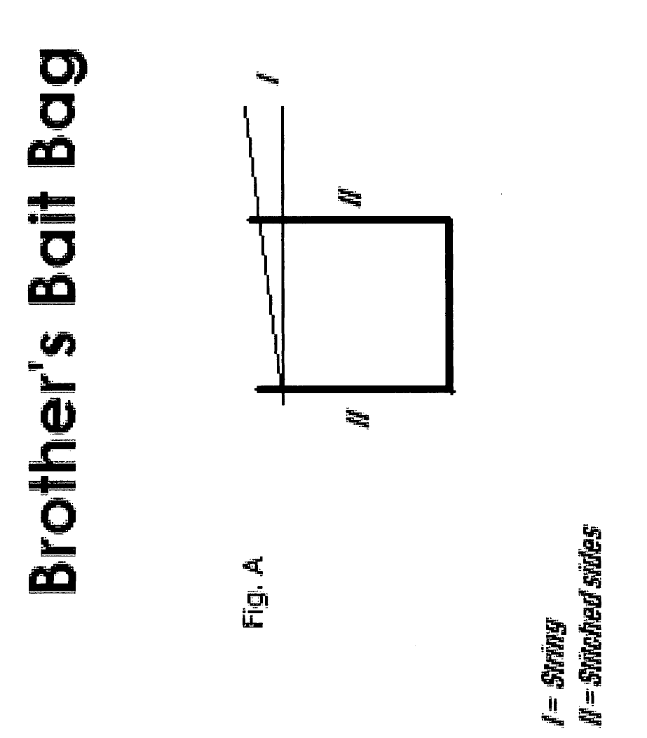

The Brothers Bait Bag is a 2×2 in. square nylon mesh bait holder and chum bag. It is made by cutting 4 in. squares from rolls of “ultra thin” nylon mesh material called (Nylon Tull). The four inch squares are folded in half to make the square. The sides are sewn together with cotton thread matching the color of the material used to make the bag. Then a drawstring is sewn through the sides of the bag at the top portion (open-end) of the bag giving means for drawing the openend of the bag closed to secure a hook and bait inside the bag. The construction of the bag itself is complete with the exception of those bags which are treated with “Crab Scent” to enhance the olfactory attractiveness of the bag to certain classes of fish in fresh, brackish, and salt waters. Scented Bait Bags are made from the same bags mentioned in the above stated construction process. After the color coded drawstring for closing the top portion of the Bait Bag “closed” is in place, the bag is then dipped and soaked in crab oil and juices for a period of time to allow the scent of crab to adhere to the nylon mesh netting. The crab oil and juices are made by first: Steaming live male crabs to doneness, the meat of the crab is picked from the shell and left to soak in the water and juices produced by the act of steaming the crabs. The crab shells with legs and remains of the body are then mashed to almost paste. Bait Bags are then placed into this solution for several hours. After this period of time the bags are removed from the crab oil and juice solution and laid flat to dry naturally at cool temperature. After this process the crab scented Bait Bag is ready for use.

### ORIGIN & USE OF THE BROTHER BAIT BAG:

The Brothers Bait Bag was developed and tested by four brothers who regularly fish Maryland and Virginia beaches, peers and other waters along the Eastern Coastline using 11-15 foot surf rods and tackle to launch 5 and 6 oz. sinkers up to 200 yards to find the “Big Fish Honey Hole” for Maryland's Stripped Bass, Trout, Weakfish, and, Jumbo Croakers. These fish are all partial to Soft Crab, and, Razor Clams which are very soft and expensive baits to waste in the attempt to cast them to the special spot. Hence, the Brothers Bait Bag. Using a 1/0 to 6/0 circle hook or other Bait hook attached to a long leader, place Soft Crab or other designed bait onto the hook then slip the Brothers Bait Bag over the hook and bait then pull the drawstring portion of the bag snug on the shank to eye of the hook to secure the baits inside of the bag. Cast the hook with the leader bag attached short distances, long distances, or, bottom fish. The Crab Scented bag containing fresh Soft Crab, or, Peeler Crab will leave a Chum slick in the vicinity of your hook as the Crab Scented oils and juices are released from the mesh material. Helping to produce strikes by fish.

1.) In a fishing lure composing of a bag having sidewalls formed of open mesh material closed at one end and open at opposite end having means for drawing the open end closed (drawstring) thereby enclosing the fishhook within the bag, and, a leader attached to the fishhook extending through the open end of the bag, such that the bag is slideably mounted soley on the fishhook whereby bait may be placed on the fishhook and the bag then closed by said means, the bait being reasily visible and olfactorily attractive to fish by reason of the open mesh characteristic of the bag, and the pointed end of the fishhook readily able to penetrate the bag by reason of its open mesh characteristics for hooking a fish, the improvement comprising wherein the bag is made of a nylon mesh material is designed to catch any class of fish and is open only at one end, whereby the bait may be placed on the fishhook in the bag, and the bag being closed at the top with a drawstring and slideably mounted on a hook.

2.) The fishing lure of claim (1.), further comprising wherein the open mesh bag is soaked in a desired shellfish, or, fish oil to enhance the olfactory attractiveness to a specific class of fish.

3.) The fishing lure of claim (2.) wherein the specific fish is salt water or brackish water ie.: Rockfish, Croaker, or, Trout wherein the said oil is crab oil or various fish or shellfish oils attractive to these species.

4.) The fishing lure of claim (2.), wherein said bait is placed in the open mesh bag is soft crabs, and wherein the bait is not attached to the fishhook.

5.) A method for catching a particular class of fish, wherein said compromises utilizing the fishing lure of claim (1.), wherein the method compromises:
a.) Presoaking the open mesh bag in a desired oil to enhance the olfactory attractiveness to a specific class of fish,
b.) Placing soft crab into the bag,
c.) Affixing the bag is slideabley mounted onto a hook attached to a leader.

6.) The mesh bag as set forth in claim (1.) is produced in various colors to enhance the visual attractiveness of the bait and bag to fish.
